(19) United States
(12) Patent Application Publication
(10) Pub. No.: US 2014/0028689 A1
(43) Pub. Date: Jan. 30, 2014

(54) METHOD, APPARATUS, AND SYSTEM FOR EXPANDING GRAPHICAL PROCESSING VIA AN EXTERNAL DISPLAY-DATA I/O PORT

(71) Applicant: Sing Hook Arther Teng, Bavan Lepas (MY)

(72) Inventor: Sing Hook Arther Teng, Bavan Lepas (MY)

(21) Appl. No.: 13/993,315

(22) PCT Filed: Dec. 16, 2011
(86) PCT No.: PCT/US11/65469

§ 371 Date: Jun. 11, 2013

(51) Int. Cl. G09G 5/00

(52) U.S. Cl. CPC G09G 5/006
USPC 345/520

(57) ABSTRACT

Described herein are an apparatus, method, and system for expanding graphical processing via an input-output (I/O) interface (e.g., Thunderbolt™) for transmitting and receiving serial data and display data simultaneously. The apparatus comprises: one or more graphical processing units (GPUs); and an I/O interface for transmitting and receiving serial data and display data simultaneously, wherein the I/O interface for communicatively coupling the one or more GPUs externally to a computing device.

### CLAIM OF PRIORITY

This application claims the benefit of priority of International Patent Application No. PCT/US2011/065469 filed Dec. 16, 2011, titled “METHOD, APPARATUS, AND SYSTEM FOR EXPANDING GRAPHICAL PROCESSING VIA AN EXTERNAL DISPLAY-DATA I/O PORT,” which is incorporated by reference in its entirety.

### BACKGROUND

As videos and games are becoming more graphic intensive (e.g., three dimensional videos and games), the demand for more powerful graphics processing units (GPUs) is increasing. However, more powerful GPUs mean more computing power and thus higher power consumption. Accordingly, the more powerful GPUs are not available for mobile devices such as laptops, smart devices (e.g., smart phones), tablet PCs, net-books, and low power desktops, etc, because such mobile devices lack the physical capacity to provide additional integrated processors like GPUs and/or to provide the necessary power needed to run such GPUs, and/or the associated heat transfer mechanisms to keep the temperature of the mobile devices within their specifications.

### BRIEF DESCRIPTION OF THE DRAWINGS

Embodiments of the invention will be understood more fully from the detailed description given below and from the accompanying drawings of various embodiments of the invention, which, however, should not be taken to limit the invention to the specific embodiments, but are for explanation and understanding only.

FIG. 1 illustrates a system in which one or more graphics processing units (GPUs) are integrated to a computing device via an input-output (I/O) interface having a combined display and data ports within the I/O interface, according to one embodiment of the invention.

FIG. 2A illustrates a system in which one or more GPUs are integrated to the computing device via a Thunderbolt™ I/O interface, according to one embodiment of the invention.

FIG. 2B illustrates a Thunderbolt™ cable for communicatively coupling the computing device with the one or more GPUs, according to one embodiment of the invention.

FIG. 3 is a method flowchart for enhancing graphical processing for a computing device, according to one embodiment of the invention.

FIG. 4 is a method flowchart executed by the computing device for enhancing its graphical processing capabilities, according to one embodiment of the invention.

FIG. 5 illustrates a computer system which is operable to expand its graphical processing capabilities, according to one embodiment of the invention.

FIG. 6 illustrates embodiments of a small form factor device in which the computer system of FIG. 5 may be embodied and which is operable to expand its graphical processing capabilities.

### SUMMARY

The following presents a simplified summary of the embodiments of the invention in order to provide a basic understanding of some aspects of the embodiments. This summary is not an extensive overview of the embodiments of the invention. It is intended to neither identify key or critical elements of the embodiments nor delineate the scope of the embodiments. Its sole purpose is to present some concepts of the embodiments of the invention in a simplified form as a prelude to the more detailed description that is presented later.

Embodiments of the invention relate to an apparatus, method, and system for expanding graphical processing via an input-output (I/O) interface (e.g., Thunderbolt™) for transmitting and receiving serial data and display data simultaneously.

In one embodiment, the apparatus comprises: one or more graphical processing units (GPUs); and an input-output (I/O) interface for transmitting and receiving serial data and display data simultaneously, wherein the I/O interface for communicatively coupling the one or more GPUs externally to a computing device.

In one embodiment, the method comprises communicatively coupling one or more GPUs externally with a computing device via an I/O interface, the I/O interface for transmitting and receiving serial data and display data simultaneously.

In one embodiment, the system comprises: a computing device with a display unit; and a graphical processing card, communicatively coupled to the computing device, the graphical processing card including: one or more GPUs; and an I/O interface for transmitting and receiving serial data and display data simultaneously, wherein the I/O interface for communicatively coupling the one or more GPUs externally to the computing device.

The following description and the annexed drawings set forth in detail certain illustrative aspects of the embodiments of the invention. These aspects are indicative, however, of but a few of the various ways in which the principles of the embodiments of the invention may be employed. The embodiments of the invention are intended to embrace all equivalents in the form of alternatives, modifications, and variations that fall within the broad scope of the appended claims. Other advantages and novel features of the embodiments of the invention will become apparent from the following detailed description of the embodiments of the invention when considered in conjunction with the drawings.

### DETAILED DESCRIPTION

Embodiments of the invention relate to an apparatus, method, and system for expanding graphical processing capabilities for a computing device (e.g., laptop, desktop, tablet PC, smart device, net-book, e-book, etc, via a fast input-output (I/O) interface coupled to a fast cable for transmitting and receiving serial data and display data simultaneously.

There are many technical effects caused by the embodiments discussed herein. For example, by providing graphics enhancement capabilities to a computing device, high graphics intensive games and videos can be played or executed on the computing device, which is now enhanced with one or more graphical processing units (GPUs). Furthermore, by using at least a dual-protocol fast I/O interface with combined display and data ports that can operate using industry standard and widely available software drivers, for example drivers for Peripheral Component Interconnect Express (PCI Express™) and DisplayPort™, the one or more GPUs can be communicatively coupled to the computing device with little, if any, upgrade to the software of the computing device.

In one embodiment, the I/O interface is hot pluggable, i.e. the external one or more GPUs added to the computing device via a fast cable coupled to the I/O interface are seamlessly recognized by the computing device without having to reboot the computing device. In such an embodiment, the graphics processing capabilities of the computing device can be enhanced on demand without having to change the underlying hardware of the computing device.

In one embodiment, the power dissipation of the computing device is lowered by providing a separate power supply connection to the one or more GPUs. In such an embodiment, the form factor of the computing device can be made smaller than its previous size, and thus the cost of the computing device can be lowered, because the computing device does not need the high processing powered GPUs and associated logic units within its casing.

In the following description, numerous details are discussed to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

In the following description and claims, the term “coupled” and its derivatives may be used. The term “coupled” herein refers to two or more elements which are in direct contact (physically, electrically, magnetically, optically, etc.). The term “coupled” herein may also refer to two or more elements that are not in direct contact with each other, but still cooperate or interact with each other.

As used herein, unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

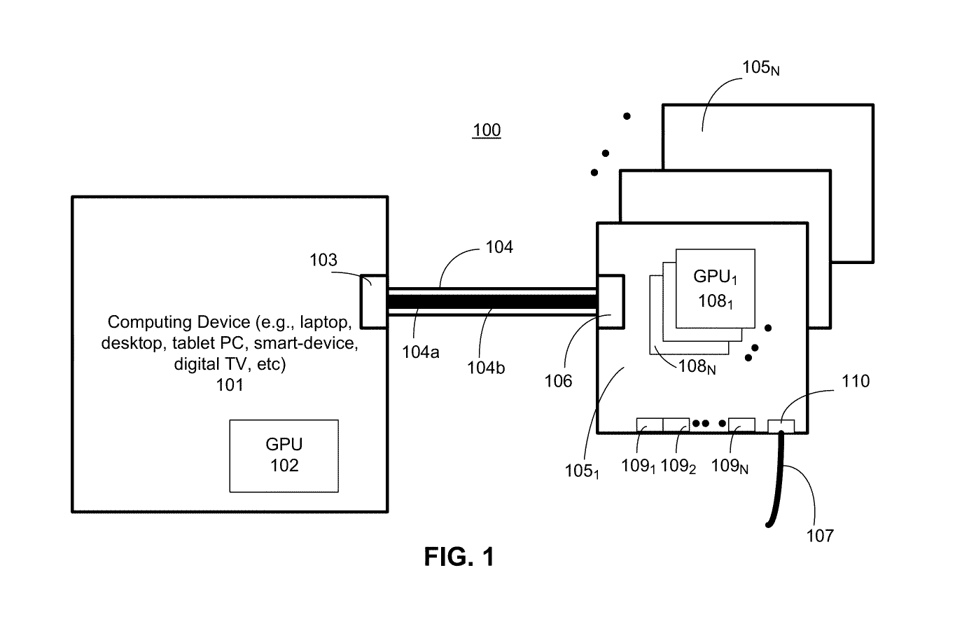

FIG. 1 illustrates a system 100 in which one or more GPUs are integrated to a computing device 101 via an I/O interface 103 having a combined display and data ports within the I/O interface, according to one embodiment of the invention. In one embodiment, the computing device 101 is at least one of: a laptop computer; a net-book computer; a tablet PC; a desktop computer, a smart device (e.g., a smart phone), a digital TV, etc or any other computing device capable of processing and/or displaying video. In one embodiment, the computing device 101 includes its own GPU 102 which is operable to be functionally combined with the one or more GPUs integrated with the computing device via the I/O interface 103.

In one embodiment, the I/O interface 103 couples to a cable 104 which is capable of carrying, i.e. sending and receiving, serial data 104a and display data 104b simultaneously and bi-directionally. In one embodiment, the I/O interface 103 includes: a PCI Express™ port for sending and receiving serial data that meets the PCI Express™ specification, and a DisplayPort™ for sending and receiving the display data. In one embodiment, the DisplayPort™ is compatible with at least one of: MiniDisplayPort (MDP), High Definition Multimedia Interface (HDMI), Firewire, Digital Visual Interface (DVI), Dual-link DVI, Video Graphics Array (VGA), or Low Voltage Differential Signal (LVDS) port. In other embodiments, other data and display protocols may be used for integrating the GPUs to the computing device 101 without changing the essence of the embodiments.

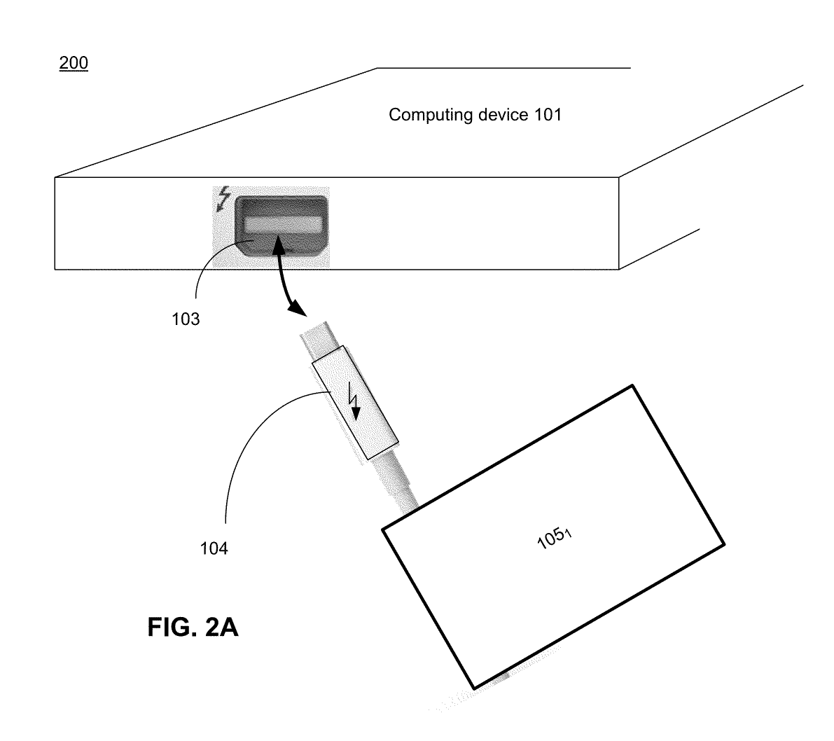

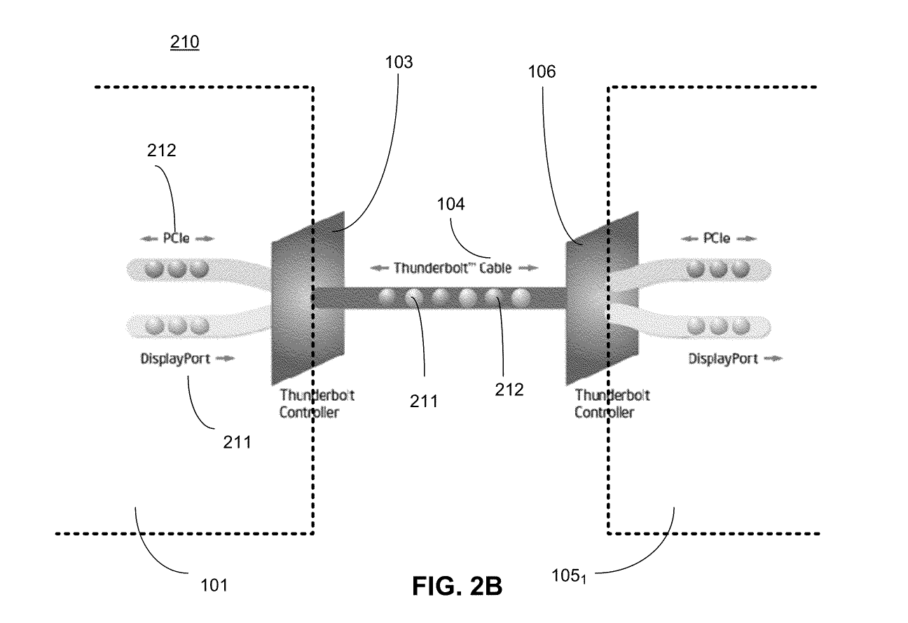

In one embodiment, the I/O interface 103 is a Thunderbolt™ interface as described with reference to FIGS. 2A-B. Thunderbolt™ is a fast bus interface developed by Intel® Corp. of Santa Clara, Calif. The Thunderbolt™ interface integrates PCI Express™ data and DisplayPort™ data to be transmitted and received over the same cable 104 (also called Thunderbolt™ cable) simultaneously.

Referring back to FIG. 1, in one embodiment the one or more GPUs 108_{1-N} are provided on a single platform 105₁, where N is positive integer. In one embodiment, multiple platforms 105_{1-N} may be coupled together to enhance the overall graphics processing capability of the computing device 101. In one embodiment, the multiple platforms 105_{1-N}, each having its own set of GPUs are coupled together in a daisy chain network topology. In other embodiments, other forms of network topologies (e.g., star topology) may be used without changing the essence of the embodiments of the invention.

In one embodiment, each platform (e.g., 105₁) includes a power supply port 110 for coupling to a power supply source via a cable 107. In one embodiment, the multiple platforms 105_{1-N} share a single power supply port 110 that provides power to all the multiple platforms 105_{1-N}. In one embodiment, each platform (e.g., 105₁) includes a similar I/O interface 106, similar to the I/O interface 103, to send and receive serial data and display data over the cable 104. In one embodiment, a single cable 104 is used to send and receive serial data and display data for all the multiple platforms 105_{1-N}. One reason for having a separate power supply port 110 for the one or more platforms 105_{1-N} is to reduce the power supply burden on the computing device 101. In such an embodiment, the computing device 101 can process or render high graphics intensity videos (e.g., 3D videos) for a user of the computing device 101 without having to extend its form factor (dimensions of the casing) to realize extra power supply or batteries.

In one embodiment, each platform (e.g., 105₁) includes one or more display ports 109_{1-N} to allow the computing device to communicatively couple to one or more display units and other computing devices. For example, the 109_{1-N} ports include MiniDisplayPort (MDP), High Definition Multimedia Interface (HDMI), Firewire, Digital Visual Interface (DVI), Dual-link DVI, Video Graphics Array (VGA), or Low Voltage Differential Signal (LVDS) port, etc.

In one embodiment, firmware of the computing device 101 is modified so that it may detect one or more platforms 105_{1-N} plugged to the computing device 101 via the I/O interface 103. In one embodiment, the I/O interface 103 is a hot-pluggable interface. In such an embodiment, the firmware (not shown) recognizes the one or more platforms 105_{1-N} plugged to the computing device 101 seamlessly without having to reboot the computing device 101.

In one embodiment, the one or more GPUs 108_{1-N} are operable to process the serial and display data in combination with data from the GPU 102 in the computing device 101. In such an embodiment, the computing device 101 is operable to take advantage of more processing power than provided by its own GPU 102 alone. In one embodiment, the firmware switches the existing GPU 102 in the computing device 101 for the additional high performance GPUs 108_{1-N} integrated via the I/O interface 103. In such an embodiment, the high performance GPUs 108_{1-N} are operable to process the serial and display data in the absence of any GPU in the computing device 101.

In one embodiment, the firmware prioritizes the local GPU 102 over the external one or more GPUs 108_{1-N} for all normal low performance video processing, e.g. 2D video rendering. In one embodiment, the firmware is operable to enable processing of data by the one or more GPUs 108_{1-N} when the firmware determines that the GPU 102 lacks the processing capability to process the graphics data alone (e.g., for rendering a 3D video), or when the battery life of the computing device 101 falls below a threshold (e.g., 20% remaining battery life left), or when the graphics data is such that a user will experience a higher quality video display when the graphics data is processed by the one or more GPUs 108_{1-N} instead of the GPU 102, or combination of any of the above reasons. The reasons for switching over to the one or more GPUs 108_{1-N} are not meant to be exclusive. Other reasons for switching over to the one or more GPUs 108_{1-N} or giving priority to the one or more GPUs 108_{1-N} over the local GPU 102 are contemplated herein.

FIG. 2A illustrates a system 200 in which one or more GPUs 108_{1-N} in one or more platforms 105_{1-N} are integrated to the computing device 101 via a Thunderbolt™ I/O interface 103, according to one embodiment of the invention. So as not to obscure the embodiments of the invention, only platform 105₁ is illustrated. In one embodiment, a Thunderbolt™ cable 104 is used for communicatively coupling the platform 105₁ to the communicating device 101. In one embodiment, the Thunderbolt™ cable 104 when inserted in the Thunderbolt™ I/O interface 103 causes the computing device 101 to seamlessly recognize the platform 105₁ and its associated GPUs 108_{1-N} without having to reboot the computing device 101, i.e. the Thunderbolt™ cable 104 is hot-pluggable. In one embodiment, the computing device switches all graphic intensive processing over to the GPUs 108_{1-N} of the platform 105₁.

In one embodiment, the Thunderbolt™ cable 104 includes a flexible optical fiber (not shown) for faster data transfer. The optical fiber cable 104 provides shielding from electromagnetic interference and so the quality of the video processed by the one or more graphical platforms 105_{1-N} is not compromised. In one embodiment, the Thunderbolt™ cable 104 with the optical fiber is 125 microns thick and is capable of transferring data at 10 Gb/s through up to 100 Gb/s. In these embodiments, the Thunderbolt™ cable 104 is faster than Universal Serial Bus (USB) 3.0 cables and corresponding USB 3.0 I/O interfaces. In one embodiment, the Thunderbolt™ I/O interface 103 and corresponding cable 104 ace capable of transmitting and receiving data from multiple protocols at once over the single cable 104. For example, the Thunderbolt™ cable 104 can transmit and receive video and audio streams as well as regular data on the single cable 104.

In one embodiment, the Thunderbolt™ cable 104 is operable to carry signals in both directions simultaneously at high transfer rates, for example 10 Gbps, to provide support for at least two different I/O protocols including PCI Express™ and DisplayPort™, to allow the one or more platforms 105_{1-N} to be connected with one another in a daisy-chain network topology, to provide the capability of carrying data through the cable 104 by metal wires or optic fibers or both, to provide compatibility with native protocol software drivers, for example the same PCI Express™ drivers can be used for the Thunderbolt™ I/O interface that are being used normally by the computing device 101, to provide at least 10W of power supply through the cable 104 to the one or more platforms 105_{1-N}, etc.

In the embodiments discussed herein, the Thunderbolt™ cable 104 provides low power computing devices, such as the computing device 101, with high power and high performance graphics processing platforms 105_{1-N} for high quality graphics processing and rendering.

FIG. 2B illustrates a system 210 with a Thunderbolt™ cable 104 for communicatively coupling the computing device 101 with the one or more GPUs 105_{1-N}, according to one embodiment of the invention. FIG. 2B is described with reference to FIG. 1 and FIG. 2A. In one embodiment, a single Thunderbolt™ cable 104 can carry bi-directionally both DisplayPort™ data 211 and PCI Express™ data 212 simultaneously. In one embodiment, each I/O interface (103 and 106) includes a Thunderbolt™ controller (not shown) to process the data before it is transmitted over the Thunderbolt™ cable 104 and when the data is received over the Thunderbolt™ cable 104.

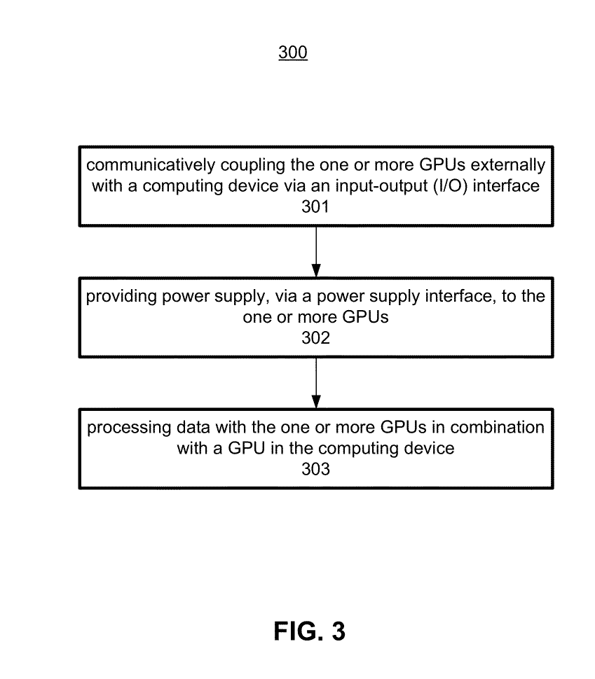

FIG. 3 is a method flowchart 300 for enhancing graphical processing for the computing device 101, according to one embodiment of the invention. Although the blocks in the flowchart 300 are shown in a particular order, the order of the actions can be modified. Thus, the illustrated embodiments can be performed in a different order, and some actions/blocks may be performed in parallel. Additionally, one or more actions/blocks can be omitted in various embodiments of enhancing graphical processing via external GPUs. The flowchart of FIG. 3 is illustrated with reference to the embodiments of FIGS. 1-2.

At block 301, one or more platforms 105_{1-N} are communicatively coupled with the computing device 101 via an I/O interface 103, the I/O interface 103 for carrying serial data and display data simultaneously over the cable 104. As described herein, in one embodiment, the I/O interface is the Thunderbolt™ interface 103 and the cable 104 is a Thunderbolt™ cable. At block 302, the one or more platforms 105_{1-N} are powered via their separate power supply interface 110 so that the computing device does not consume its own power or battery to support the extra GPUs 108_{1-N}. At block 303, the GPUs 108_{1-N} of the one or more platforms 105_{1-N} begin to process graphics data and provide the processed output to the computing device 101 and/or to any other display or computing device communicatively coupled via the interfaces 109_{1-N}.

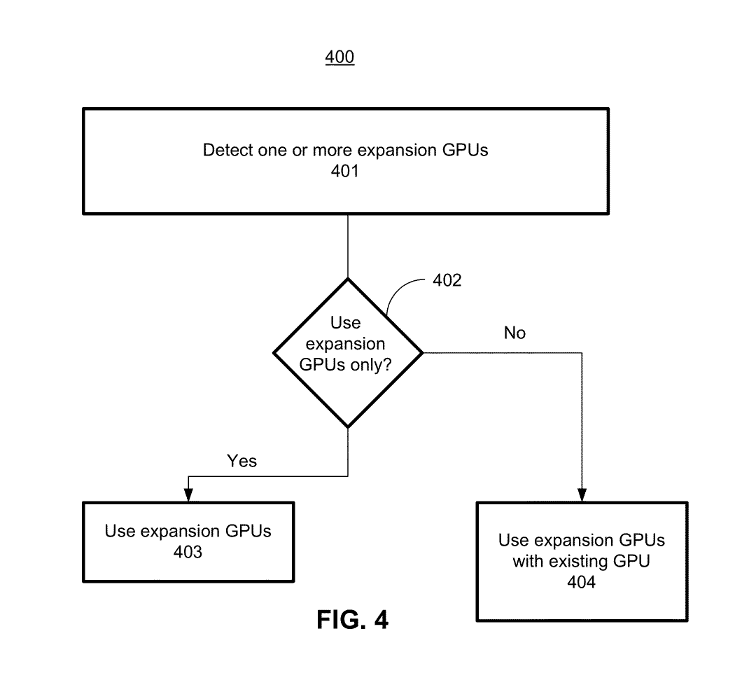

FIG. 4 is a method flowchart 400 executed by the computing device for enhancing its graphical processing capabilities, according to one embodiment of the invention. Although the blocks in the flowchart 400 are shown in a particular order, the order of the actions can be modified. Thus, the illustrated embodiments can be performed in a different order, and some actions/blocks may be performed in parallel. Additionally, one or more actions/blocks can be omitted in various embodiments of enhancing graphical processing via external GPUs. The flowchart of FIG. 4 is illustrated with reference to the embodiments of FIGS. 1-3.

At block 401, the firmware of the computing device 101 detects that one or more GPUs 108_{1-N} are connected to the computing device 101 via the I/O interface 103. As described herein, the cable 104 is hot-pluggable to the computing device 101 and so the firmware does not need to reboot the computing device 101 when the one or more GPUs 108_{1-N} are connected to the computing device 101.

At block 402, the computing device 101 determines whether to use the GPUs 108_{1-N} in addition to the existing GPU 102 of the computing device 101 for processing graphic videos. For example, the computing device 101 may determine that it cannot process the graphics data alone with its GPU 102 because the graphics processing requires rendering a 3D video and so at block 404 the computing device decides to use the extra high performance GPUs 108_{1-N} detected at block 401 in addition the GPU 102. In one embodiment, the computing device 101 determines that its battery life fell below a threshold (e.g., 20% remaining battery life left) and so it can no longer afford to use its own GPU 102. In such an embodiment, at block 403 the computing device 101 uses the GPUs 108_{1-N} instead of the GPU 102 for processing graphics.

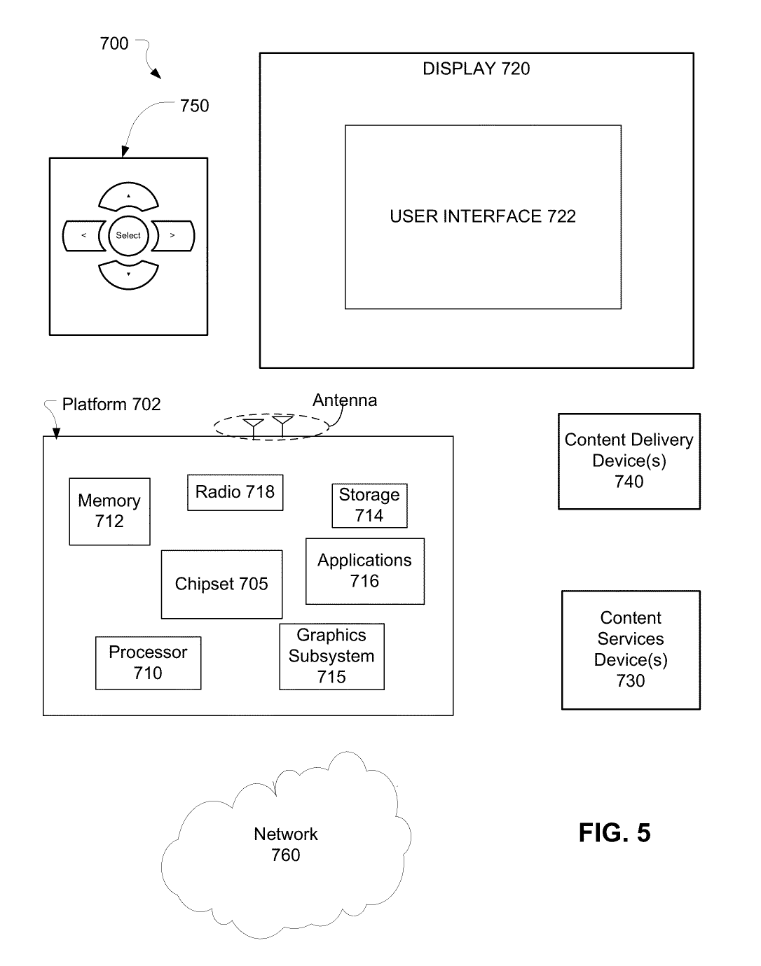

FIG. 5 illustrates a computer system 700 which operable to expand its graphical processing capabilities, according to one embodiment of the invention. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In some embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In some embodiments, the platform 105_{1-N} of FIGS. 1-2 correspond to the platform 702. In one embodiment, the platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In some embodiments, processor 710 may comprise dual-core processor(s), dual-core mobile processor(s), and so forth. In one embodiment, the processor 710 is communicatively coupled to a graphics card as discussed herein. The processor 710 executes an operating system. The system herein may also include a battery (e.g., lithium ion battery) to supply power to the processor 710.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort™, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In some embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In some embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In some embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In some embodiments, platform 702 may receive control signals from navigation controller 750 having one or more navigation features. The navigation features of controller 750 may be used to interact with user interface 722, for example. In some embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In some embodiments, controller 750 may not be a separate component but integrated into platform 702 and/or display 720. The embodiments, however, are not limited to the elements or in the context shown or described herein.

In some embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

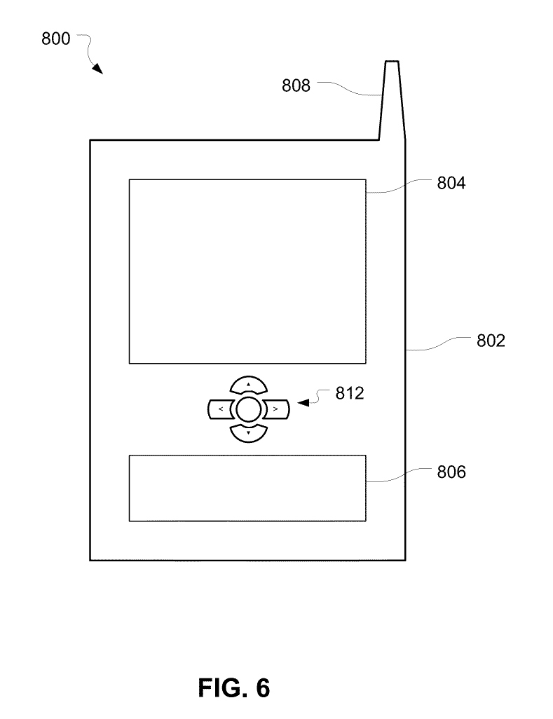

As described above, system 700 may be embodied in varying physical styles or form factors. FIG. 6 illustrates embodiments of a small form factor device 800 (also corresponds to the computing device 101) in which system 700 may be embodied and which operable to expand its graphical processing capabilities. In one embodiment, the small form factor device 800 includes an I/O interface 103 as discussed with reference to FIGS. 1-4 to integrate one or more GPUs 108_{1-N} to the small form factor device 800.

In the embodiments, for example, device 800 may be implemented as a mobile computing device having wireless capabilities. A mobile computing device may refer to any device having a processing system and a mobile power source or supply, such as one or more batteries, for example.

As described herein, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In the embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

While the invention has been described in conjunction with specific embodiments thereof, many alternatives, modifications and variations of such embodiments will be apparent to those of ordinary skill in the art in light of the foregoing description. The embodiments of the invention are intended to embrace all such alternatives, modifications, and variations as to fall within the broad scope of the appended claims.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1. An apparatus comprising:
one or more graphical processing units (GPUs); and
an input-output (I/O) interface for transmitting and receiving serial data and display data simultaneously, wherein the I/O interface for communicatively coupling the one or more GPUs externally to a computing device.

2. The apparatus of claim 1, wherein the I/O interface includes:
a Peripheral Component Interconnect Express (PCI Express™); and
a DisplayPort.

3. (canceled)

4. The apparatus of claim 1, wherein the I/O interface is a Thunderbolt™ interface.

5. The apparatus of claim 1 further comprises a power supply interface for providing power supply to the one or more GPUs.

6. The apparatus of claim 1, wherein the one or more GPUs are operable to process the serial and display data in combination with data from a GPU in the computing device.

7. The apparatus of claim 1, wherein the one or more GPUs are operable to process the serial and display data in the absence of a GPU in the computing device.

8. The apparatus of claim 1, wherein the one or more GPUs are operable to be enabled for processing data when a GPU in the computing device is unable to process the serial and display data completely by itself.

9. The apparatus of claim 1, wherein the I/O interface is a hot-pluggable I/O interface.

10. The apparatus of claim 1, wherein the I/O interface is operable to couple the apparatus with two or more computing devices in a daisy-chain network topology.

11. The apparatus of claim 1, wherein the I/O interface includes an optic fiber interface or a metal wire interface.

12. (canceled)

13. A method comprising:
communicatively coupling one or more graphical processing units (GPUs) externally with a computing device via an input-output (I/O) interface, the I/O interface for transmitting and receiving serial data and display data simultaneously.

14-20. (canceled)

21. A system comprising:
a computing device with a display unit; and
a graphical processing card, communicatively coupled to the computing device, the graphical processing card including:
one or more graphical processing units (GPUs); and
an input-output (I/O) interface for transmitting and receiving serial data and display data simultaneously, wherein the I/O interface for communicatively coupling the one or more GPUs externally to the computing device.

22. The system of claim 21, wherein the display unit is a touch screen.

23. The system of claim 21, wherein the I/O interface includes:
a Peripheral Component Interconnect Express (PCI Express™); and
a DisplayPort.

24. (canceled)

25. The system of claim 21, wherein the I/O interface is one of:
a Thunderbolt™ interface;
a hot-pluggable I/O interface;
optic fiber interface; or
a metal wire interface.

26. The system of claim 21, wherein the one or more GPUs are operable to:
process the serial and display data in combination with data from a GPU in the computing device;
process the serial and display data in the absence of a GPU in the computing device; or
to be enabled for processing data when a GPU in the computing device is unable to process the serial and display data completely by itself.

27-30. (canceled)

31. A system comprising:
an operating system;
a processor to execute the operating system;
a graphical processing card, communicatively coupled to the processor, the graphical processing card including:
one or more graphical processing units (GPUs); and
an input-output (I/O) interface for transmitting and receiving serial data and display data simultaneously, wherein the I/O interface for communicatively coupling the one or more GPUs externally to the processor;
a wireless interface to allow the processor to communicate with another device; and
a battery to provide power to the processor.

32. The system of claim 31, wherein the processor is part of a computing device which is coupled to a display unit.

33. The system of claim 32, wherein the display unit is a touch screen.

34. The system of claim 31, wherein the I/O interface includes:
a Peripheral Component Interconnect Express (PCI Express™); and
a DisplayPort.

35. (canceled)

36. The system of claim 31, wherein the I/O interface is one of:
a Thunderbolt™ interface;
a hot-pluggable I/O interface;
optic fiber interface; or
a metal wire interface.

37-42. (canceled)
